(19) United States
(12) Patent Application Publication
(10) Pub. No.: US 2026/0329034 A1
(43) Pub. Date: Oct. 22, 2026

(54) MOUNTING FIXTURE FOR OPTICAL CONNECTOR

(71) Applicant: Senko Advanced Components, Inc., Hudson, MA (US)

(72) Inventors: Yim WONG, Thousand Oaks, CA (US); Robert Ryan VALLANCE, Newbury Park, CA (US); Yang CHEN, Camarillo, CA (US)

(21) Appl. No.: 19/577,345

(22) Filed: Mar. 24, 2026

Related U.S. Application Data
(60) Provisional application No. 63/776,376, filed on Mar. 24, 2025.

(51) Int. Cl. G02B 6/42

(52) U.S. Cl. CPC G02B 6/4292; G02B 6/4228

(57) ABSTRACT

A mounting fixture for mounting a connector unit to a receptacle, comprising: a first two-dimensional array of first passive alignment demountable coupling features provided on a first coupling surface of the connector unit; a complementary, second two-dimensional array of complementary, second passive alignment demountable coupling features provided on a second coupling surface of the receptacle, wherein the receptacle is aligned and positioned with respect to an optoelectronic unit; a resilient element providing a preload on the connector unit; a bracket securely positioned in relation to the receptacle; a cover attached to the bracket, wherein the resilient element biases the connector unit against the receptacle to seat and mate the complementary first and second passive alignment features on the facing first and second coupling surfaces, thereby facilitating demountable mechanical coupling of the connector unit to the optoelectronic unit.

### 1. PRIORITY CLAIM

This application claims the priority of U.S. Provisional Patent Application No. 63/776,376 filed on Mar. 24, 2025, which is fully incorporated by reference as if fully set forth herein. Further, all publications noted below are fully incorporated by reference as if fully set forth herein.

### 2. FIELD OF THE INVENTION

The present invention relates to optical coupling optical fibers to optoelectronic components, and more particularly to demountable coupling high-density optical connectors to optoelectronic components (e.g., photonic integrated circuits (PICs)).

### 3. DESCRIPTION OF RELATED ART

Photonic integrated circuits (PICs) or integrated optical circuits are part of an emerging technology that uses light as a means of communication as opposed to an electric current. A PIC device integrates multiple photonic functions analogous to electronic chips, but providing functionalities for information signals imposed on optical wavelengths typically in the visible spectrum or near infrared 850 nm-1650 nm.

A PIC device (e.g., in the form of a silicon photonic chip package referred to as SiPIC) typically uses optical waveguides to route optical signals and/or interconnect various on-chip elements, such as optical switches, couplers, routers, splitters, multiplexers/demultiplexers, modulators, amplifiers, wavelength converters, optical-to-electrical (O/E) and electrical-to-optical (E/O) signal converters, etc. For proper operation, a PIC typically needs to efficiently couple light between multiple external optical fibers and on-chip waveguides with submicron positional accuracy to minimize optical insertion losses.

Development of photonic devices led to optical multichip modules (MCMs) being implemented to allow multiple integrated circuits and multiple PICs to be modularly incorporated into larger complex packages. This helps improve yields over conventional monolithic integrated circuits. A multi-chip module (MCM) consists of multiple integrated circuits that could be ASICs, CPUs, memory stacks or other ICs attached and packaged on a unifying common support (e.g., an organic PCB, silicon interposer, or glass interposer), which may include other discrete components, so that in use it can be treated as if it were one large circuit.

In recent years, co-packaged optics (CPO) have been developed, which are advanced MCMs involving specific, advanced types of photonic circuits alongside electronic integrated circuits (e.g., an electronic device, a PIC, a chip-on-wafer device, a silicon photonic IC, a photonic wafer, and/or the like). A CPO module typically involves placing at least one PIC, which handles optical functions, and at least one electronic integrated circuit (EIC), which manage the electrical signals, in close proximity to one or more processing unit (e.g., EIC in the form of a switch ASIC or CPU/GPU) on a shared substrate or interposer. “Optical engines” or “photonic engines” in the form of “chiplets” have been developed which typically consist of a PIC and an EIC in each chiplet. Optical engines can be placed directly next to the main processing unit. This heterogeneous integration of CPO achieves a system of chips in one package, bringing together optical engines and main processing unit to drastically reduce the electrical path length from centimeters to millimeters. By bringing the optics directly into the package closer with the main processing unit, CPO eliminates the need for traditional pluggable transceiver modules on an external front panel. Unlike pluggable transceivers, the optical engines are integrated onto the same substrate or package as the main processing unit, reducing power consumption and latency by shortening the distance electrical signals travel.

CPO technologies lead to a compact, high-efficiency multi-chip module that converts electrical signals from a main processing chip (like an ASIC or GPU) directly into optical signals for fiber transmission and in reverse converts optical signals from fiber input to electrical signals to be electronically processed. By replacing the relatively larger pluggable transceivers, CPO allows for more I/O ports within the same space. By increasing the density of optical I/O ports placed around a processing unit, a CPO can handle high-data-rate traffic in AI and machine learning applications. CPOs are being developed for deployment in high-density artificial intelligence (AI) data centers, which include XPUs and network switches.

To optically couple optical fibers to optical engines, an optical connector supporting one of more arrays of optical fibers is mounted in optical alignment with the I/O ports of one or more optical engines. This would require additional structural complexity in accurately and securely positioning each optical connector in optical alignment with the I/O ports of the corresponding optical engines. Increased density of optical I/O ports in a CPO introduces further challenges to achieving and maintaining submicron accuracy for optical coupling optical fibers to a CPO.

US Patent Publication No. US2024/0085633A1 (commonly assigned to the assignee of the present application and fully incorporated by reference herein) discloses configurable optical connector modules having a plurality of discrete optical benches supporting an array of optical fibers inputting/outputting optical signals. A carrier commonly supports the optical benches, with the optical benches fixedly mounted thereon in a desired spatial arrangement with the optical inputs/outputs of the optical benches matching optical inputs/outputs of corresponding external optoelectronic components in an MCM (e.g., by active alignment). The carrier includes passive alignment features (e.g., conforming to elastic averaging alignment coupling) for demountable coupling to the external components.

The large number of multifiber optical benches presents additional challenges to achieve and maintain optical alignment between the optical fibers and the optoelectronic components. The larger form factor of an optical connector module having a row of many multifiber-optical benches requires significant challenges to ensure positional accuracy of the optical benches to achieve and maintain acceptable optical alignment accuracy between the optical fibers across the entire row of optical benches and corresponding I/O ports of the optoelectronic components. Optical misalignments across the large form factor can lead to substantial optical insertion losses. Furthermore, a demountable optical connector module that is repeatedly mated and unmated with the optoelectronic components would require further considerations to achieve and maintain alignment accuracy. Moreover, once optical benches are permanently attached to the carrier in an optical connector module, a faulty fiber array associated with a particular optical bench cannot be effectively removed and replaced (i.e., separation of the optical bench from the carrier would be destructive.

US Patent Publication No. US2025/0284077A1 (commonly assigned to the assignee of the present application and fully incorporated by reference herein) discloses demountable coupling an optoelectronic component (e.g., a PIC) and an optical connector. A receptacle having an optical window is positioned in reference to optical I/O ports of the optoelectronic component. Matching demountable passive alignment features (e.g., conforming to elastic averaging alignment coupling) are provided on the facing surfaces between the receptacle and a cover plate of the optical connector. A preload is required to bias the optical connector to the receptacle to maintain the passive alignment coupling.

U.S. patent application Ser. No. 19/564,153, published as US Patent Publication No. ______ (commonly assigned to the assignee of the present application and fully incorporated by reference herein) discloses an optical connector module assembly for demountable coupling an array of discrete connector units to an array of receptacles associated with an array of optoelectronic units by passive alignment. A frame detachably supporting the connector units with a clearance between the frame and corresponding connector units, permitting individual connector units to suspend or float with respect to the frame. A biasing member between a back cover and the connector units, providing a preload biasing each connector unit in a vertical direction perpendicular towards the first coupling surface. The connector units are independently movable to separately locate and coupled to a corresponding receptacle under the preload.

The present invention further provides alternate embodiments of mounting and preloading of connector units to receptacles for demountable coupling by passive alignment.

### SUMMARY OF THE INVENTION

The present invention provides a fixture for mounting optical connector units for optically coupling to external optoelectronic units (e.g., a PIC or an optical engine including a PIC within an MCM (e.g., a CPO module)) via receptacles, with improved tolerance, manufacturability, ease of assembly and use, easy of repair, demountable coupling efficiency and reliability at reduced costs.

In one aspect of the present invention, a receptacle having a coupling surface with a two-dimensional array of passive alignment demountable coupling features is aligned and positioned with respect to an optoelectronic unit. Matching/complementary two-dimensional arrays of passive alignment demountable coupling features are provided on a coupling surface of the connector unit facing the receptacle. A reliable and consistent preload on the connector unit is provided by a spring member (e.g., leaf spring, compression coil spring, elastomeric spring, etc.). When the connector unit is mounted onto the receptacles, the spring member biases the connector unit against the receptacle to locate, seat and mate the complementary passive alignment features on the facing coupling surfaces, thereby facilitating demountable mechanical coupling of the connector unit to the optoelectronic unit.

By predefining the amount of preload to be exerted by the spring member on the connector unit, when mounting/assembling the connector unit onto receptacle, the spring member asserts a predefined amount of preload on the connector unit without overloading for purpose of seating and mating the passive alignment features on facing coupling surfaces.

In one aspect of the present invention, the novel mounting fixture includes a bracket securely positioned in relation to one or more receptacles. At least one connector unit having passive alignment features on a coupling surface is placed on the coupling surface of a corresponding receptacle. A spring member is placed on the back of the body of the connector unit. In an embodiment, the body of the connector unit includes a pressure block against which the spring member biases. A cover is securely attached to the bracket, with the spring member in a compressed state between the cover and the connector unit. The connector unit is not constrained by fixed attachment to the cover or the bracket and is moveable in a direction perpendicular to the receptacle against the bias of the spring member. The connector unit is therefore not constrained to an extent for a desired tolerance range of lateral movements in a horizontal plane parallel to the plane of the corresponding receptacle. The connector unit is therefore permitted to move within a desired tolerance range relative to the cover and receptacle, with degrees of freedom including at least translations along vertical axis (Z-axis) and horizontal axes in a horizontal plane parallel to the coupling surface of the receptacle (X-axis and Y-axis orthogonal to the Y-axis) and rotation about vertical axis (Z-axis) (and further to some extent about the horizontal axes). The extent of such movement would depend on the extent of spring bias (and/or flexure) of the spring member.

The complementary passive alignment features at the facing coupling surfaces of a connector unit and a receptacle provide repeatable, fine alignment between corresponding connector unit and receptacle. Upon demountable coupling the connector unit to the receptacle, the connector unit is movable to allow the passive alignment features of the connector unit to locate, seat and mate with the passive alignment features of the receptacle, thereby physically and optically aligning the connector unit to the optoelectronic unit.

In another aspect of the present invention, a plurality of connector units (e.g., in a linear array) corresponds to/associated with one or more receptacles (e.g., in a linear array). A plurality of connector units having passive alignment features on a coupling surface is placed on the coupling surface of at least one corresponding receptacle. A bracket is securely positioned in relation to one or more receptacles. Each of the connector units is biased by a biasing member (e.g., a biasing member comprising an array of spring members). A cover (which may be a one-piece or multi-piece structure) is securely attached to the bracket, with the spring members in a compressed state between the cover and the connector units. Each connector unit is not constrained by fixed attachment to the cover or the bracket and is moveable in a direction perpendicular to the receptacle against the bias of the spring member. Each connector unit is therefore not constrained to an extent for a desired tolerance range of lateral movements in a horizontal plane parallel to the plane of the corresponding receptacle. Each connector unit is therefore permitted to move within a desired tolerance range relative to the cover and receptacle, with degrees of freedom including at least translations along vertical axis (Z-axis) and horizontal axes in a horizontal plane parallel to the coupling surface of the receptacle (X-axis and Y-axis orthogonal to the Y-axis) and rotation about vertical axis (Z-axis) (and further to some extent about the horizontal axes). The extent of such movement would depend on the extent of spring bias (and/or flexure) of the spring member.

Upon demountable coupling the connector units to the at least one receptacle, the connector unit is movable to allow the passive alignment features of the connector units to locate, seat and mate with the passive alignment features of the receptacle (e.g., facilitated by one or more coarse alignment guides in sequence), thereby physically and optically aligning the connector units to the optoelectronic unit.

The individual connector units can move relative to each other below the cover. Upon coupling the connector units to the array of receptacles, each connector unit is separately moveable to separately locate and align with a corresponding receptacle. As a result, misalignment considerations between the connector units and the associated optoelectronic unit is confined to possible “local” misalignment to an extent associated to and limited to the relatively small footprint of relatively smaller form factor of individual connector unit and corresponding receptacle, as compared to potential cumulative misalignment of connector unit(s) if they were fixedly attached within the overall relatively large/wide footprint of a relatively large form factor for a high density optical connector module.

In a further aspect of the present invention, in addition to the final alignment provided by the complementary passive alignment features at the coupling surfaces of corresponding connector unit and receptacle, a set of coarse alignment guides may be provided to facilitate initial positioning (a first level coarse alignment) of a connector unit to a receptacle. Further set of coarse alignment guides may be provided to facilitate further positioning (a second level coarse alignment) of the connector unit to the receptacle. Fine alignment (i.e., mating of the passive alignment features on the coupling surfaces of the connector and receptacle) are facilitated by the set(s) of coarse alignment guides (e.g., in sequence if more than one set is provided).

With the foregoing summary as introduction, the present invention may be further discussed below to support the features recited in the claims.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1 is a schematic plan view of a co-packaged optics (CPO) module having receptacles, to which connector units can be removably mounted with the inventive fixture, in accordance with one embodiment of the present invention.

FIGS. 2A to 2C illustrate mounting connector units with an inventive fixture, in accordance with one embodiment of the present invention.

FIGS. 3A and 3B are enlarged view of optical benches of connector units, in accordance with one embodiment of the present invention.

FIG. 4 illustrates mounting connector units with an inventive fixture deploying a split cover, in accordance with another embodiment of the present invention.

FIG. 5 illustrates mounting connector units with an inventive fixture deploying elastomeric springs, in accordance with yet another embodiment of the present invention.

FIG. 6 illustrates mounting connector units with an inventive fixture deploying elastomeric springs and a split cover, in accordance with yet another embodiment of the present invention.

FIGS. 7A to 7E illustrate mounting connector units with an inventive fixture, in accordance with a further embodiment of the present invention.

### DETAILED DESCRIPTION OF THE PREFERRED EMBODIMENTS

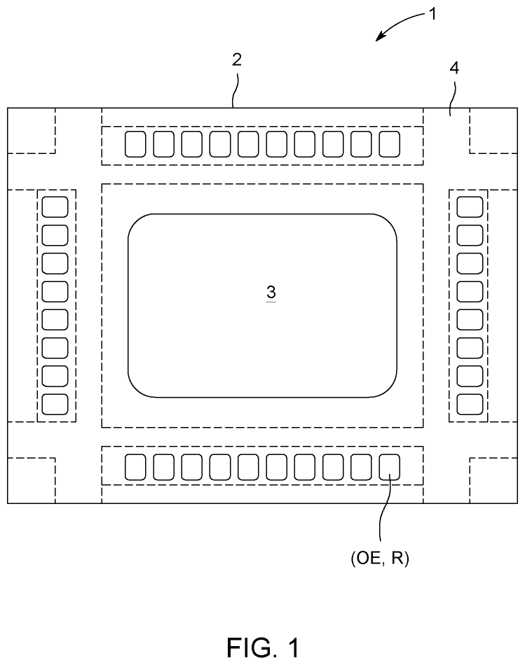

This invention is described below in reference to various embodiments with reference to the figures. While this invention is described in terms of the best mode for achieving this invention's objectives, it will be appreciated by those skilled in the art that variations may be accomplished in view of these teachings without deviating from the spirit or scope of the invention. The general configuration of the inventive mounting fixture for optical connector units will be discussed in reference to a co-packaged optics (CPO) module (hereinafter referred to simply as “CPO”) illustrated in FIG. 1, as a specific example of a multi-chip module (MCM).

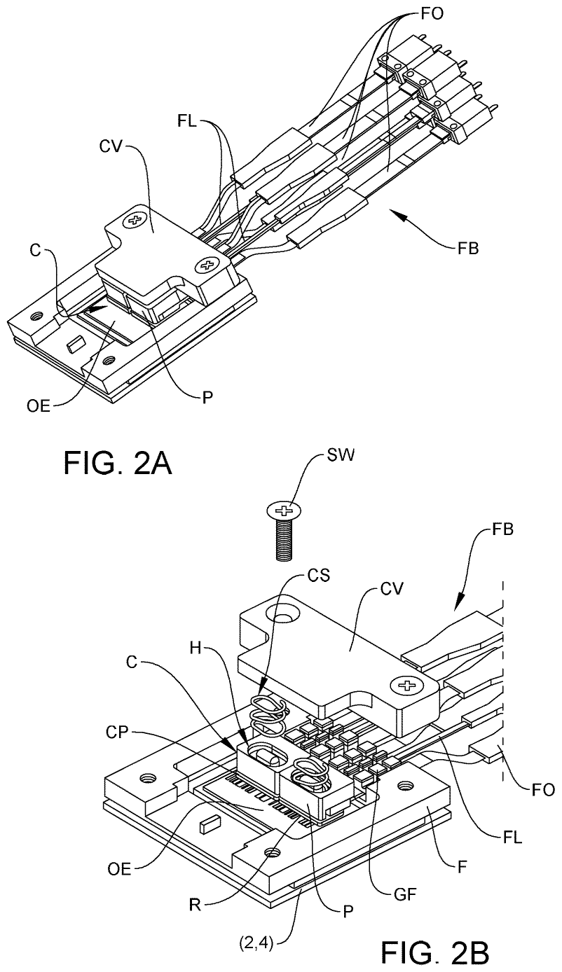

FIG. 1 is a schematic plan view of a co-packaged optics (CPO) module having receptacles, to which connector units can be removably mounted (i.e., demountably coupled to the CPO) with the inventive fixture, in accordance with the embodiments discussed below in reference to FIGS. 2 to 7. As shown in FIG. 1, the CPO 1 may include a substrate 2, a main processing unit 3, and a plurality of optoelectronic components (hereinafter referred to as “optoelectronic units” OE (e.g., photonic integrated circuits PIC, optical engines and other types of optoelectronic components). Stiffeners 4 are attached to substrate 2 to improve and maintain integrity of the substrate from warpage and other external perturbations. As also shown in FIG. 1, the main processing unit 3 may be positioned on a central portion of the substrate 2, arrays of optoelectronic units OE may be positioned on a peripheral portion of the substrate 2. An optical fiber may be used to provide an optical signal from an external source or may be used to provide an optical signal from the optoelectronic device to an external receiver. The present invention provides a mounting fixture for demountably coupling connector units by passive alignment (e.g., by kinematic, quasi-kinematic or elastic averaging coupling) to receptacles associated with the optoelectronic units OE for efficient coupling external optical fibers to optoelectronic units OE.

For simplicity of discussions, various embodiments of the inventive mounting fixtures will be discussed below in connection with a small subset of connector units and receptacles. In particular, the following embodiments include two connector units, each with at least one optical bench (in the illustrated embodiments, three optical benches), each associated with a receptacle R attached to the top of an optoelectronic unit OE. There are two receptacles R and two connector units associated with optoelectronic unit OE. However, it is within the scope and spirit of the present invention to include other embodiments, such as associating different numbers of connector units with one or more receptacles, and different numbers of optical benches (at least one) within a connector unit.

FIGS. 2A to 2C illustrate mounting connector units with an inventive fixture, in accordance with one embodiment of the present invention. Fiber array subassembly/fiber bundle FB includes several fiber arrays of optical fibers O that terminate at one end with connection units C (FIGS. 2B, 2C) and another end with connectors for connection to, e.g., external sources and/or receivers. In the illustrated embodiment throughout, the fiber bundle FB includes six fiber arrays including four fiber arrays FO for optical signals and two fiber arrays FL for external supply light source (e.g., a laser) for the optoelectronic unit OE. Specifically in the illustrated embodiments, two fiber array FO and one fiber array FL terminate with optical fibers supported by each connector unit C.

Each connector unit C for demountable coupling to receptacle R associated with the optoelectronic unit OE comprises an array of discrete optical benches corresponding to receptacle R. In the illustrated embodiments throughout, two connector units C correspond to a single receptacle R. As better shown in the enlarged view of FIG. 2C, which depicts the optical benches B and BL, with the pressure block P omitted. Connector unit C comprises two optical benches B, each supporting two arrays FO of optical fibers O for inputting/outputting optical signals to/from corresponding array of I/O ports of optoelectronic unit OE, and an optical bench BL (shown as having a narrower body with fewer optical channels) supporting one array FL of optical fibers OL for inputting, e.g., laser signal, to the corresponding ports of optoelectronic unit OE.

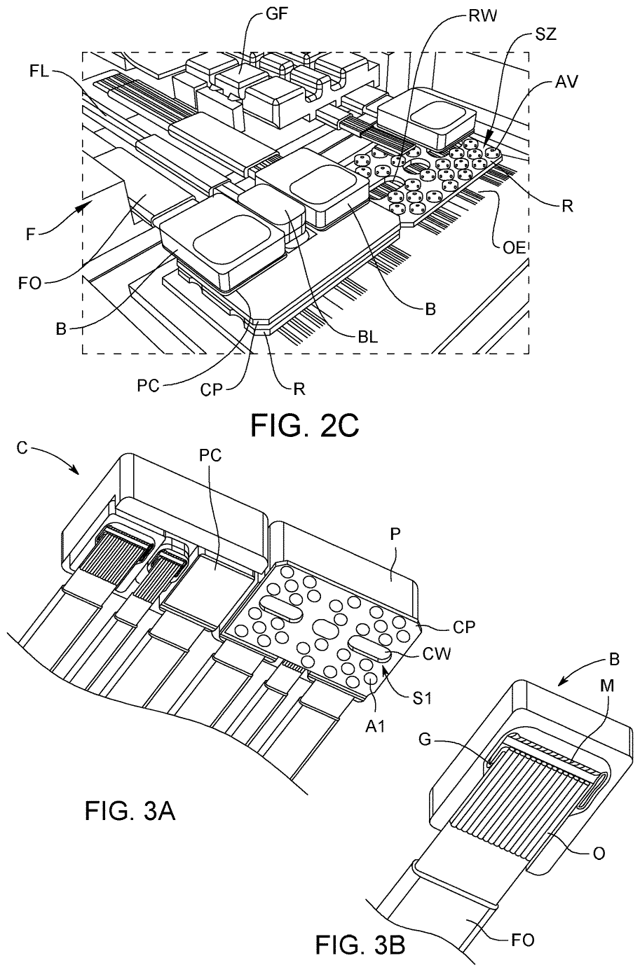

In the illustrated embodiment, receptacles R are located at and bonded to (e.g., by epoxy, solder, weld, etc.) the top of optoelectronic unit OE. Each receptacle R includes passive alignment features A2 on coupling surface S2 in alignment with respect to the I/O ports of optoelectronic unit OE. As shown in FIG. 2C, receptacles R including an optical path window RW are positioned on and in defined reference to the optoelectronic unit OE, and each receptacle R may be configured to align its optical path windows RW and optical path windows CW (FIG. 3A) of corresponding connector unit C. Passive alignment features A2 are distributed about the optical path windows CW, to allow passage of optical signals to/from connector unit C and corresponding I/O ports of optoelectronic unit OE.

In the illustrated embodiment, each receptacle R is a separate component attached to optoelectronic unit OE. The receptacle R may be actively aligned to optoelectronic unit OE before bonding to optoelectronic unit OE. Alternatively, a receptacle can be integral in the top surface of optoelectronic unit. In further embodiments, not shown, receptacles may be located relative to edge couplers along the edge of optoelectronic units. The characteristics and deployment of edge couplers for optical connectors have been extensively discussed in assignee's earlier patent publication U.S. Pat. No. 11,022,755 (and publications referenced therein). References can be made to the earlier publications for further details and adoption for the present invention, which concepts when considered alone are not germane to the practice of the present invention.

The receptacle R may be made of materials such as glass, silicon, metal, etc., formed by etching, stamping, etc. The features, structures, design considerations, making and applications of receptacles (e.g., spatial alignment of receptacles to corresponding optoelectronic units) have been discussed in early patent documents published by the common assignee of the present invention (e.g., US Patent Publication Nos. 2025/0284077A1; 2016/0161686A1; US2024/0085633A1; 2024/0142722A1). References can be made to these earlier publications for further details and adoption for the present invention, which concepts when considered alone are not germane to the practice of the present invention.

In the illustrated embodiment in FIGS. 3A and 3B, each optical bench B has a body having grooves G supporting optical fibers O substantially parallel to the first coupling surface S1, wherein the optical bench B comprises a linear array of structured optical surfaces M (e.g., free form reflective surfaces that create concave optical surfaces, internally reflective surfaces, etc.) defined in reference/relation to the first passive alignment features A1 and optically aligned with the respective optical fibers O, and wherein the array of structured optical surfaces M direct (e.g., by reflecting, folding, turning, collimating, expanding, focusing, etc.) optical signals as input/output of connector unit C. Optical bench BL for external laser light may be similarly structured, with structured optical surfaces appropriately configured for intended purpose of external laser light.

Connector unit C comprises a first coupling surface S1 provided with first passive alignment features A1 matching complementary second passive alignment features A2 provided on a second coupling surface S2 of receptacle R, and wherein removably mating the first passive alignment features A1 and the second passive alignment features A2 forms a demountable coupling between the first coupling surface S1 and the second coupling surface S2. First coupling surface S1 is at the bottom surface of connector unit C, provided with the first passive alignment features A1. In the illustrated embodiment, first coupling surface S1 is defined by a common cover plate CP commonly attached to the underside of optical benches B and BL, which defines optical path windows CW through which optical signals are transmitted to/from optical fibers in fiber arrays FO and external laser light is directed to the optoelectronic unit OE. (In addition, an optically transparent protective cover PC, or interposer, may be provided before attachment of the cover plate CP to the underside of the optical benches.) The features, structures, design considerations, making and deployments of optical benches have been discussed in early patent documents published by the common assignee of the present invention (e.g., US Patent Publication Nos. 2025/0284077A1; 2016/0161686A1; US2024/0085633A1; 2024/0142722A1; and publications referenced therein). References can be made to these earlier publications for further details and adoption for the present invention, which concepts when considered alone are not germane to the practice of the present invention.

In alternate embodiments, optical benches of other configurations may be adopted without departing from the scope and spirit of the present invention. The inventive concept of deploying floating connector units withing an optical connector assembly could adopt other configurations of optical benches that include a substrate (e.g., a glass plate) serving as a rigid platform for aligning and mounting multiple, discrete optical fibers, and any required optical components (e.g., optical surfaces, lenses, etc.) to facilitate transmission of optical signals to/from the optical fibers.

The inventive mounting fixture includes a bracket F securely positioned in relation to receptacle R. Frame F may be securely attached to stiffener 4 and/or substrate 2 in FIG. 1. Connector unit C having passive alignment features on a coupling surface is placed on the coupling surface of a corresponding receptacle. A biasing member (made of resilient/flexible material) is placed on the back of connector units CS. In the embodiment of FIG. 2, the biasing member includes separate spring members CS (i.e., an array of spring members) for corresponding connector units, which may be a compression coil spring (e.g., having an oval section). Referring also to FIG. 3A, connector unit C includes a pressure block P commonly attached to the backs of the two optical benches B and optical bench BL.

Optical benches B and BL are pre-aligned spatially relative to each other and relative to the cover plate CP and receptacle R, e.g., by active alignment and then fixedly attaching the cover plate CP and block P to the undersides and backs of the optical benches (e.g., by laser welding). Active aligning and fixedly mounting an array of discrete optical benches to a cover plate having active alignment features and a backing carrier in a desired spatial configuration that is aligned with a receptacle have been extensively discussed in assignee's earlier patent publications (e.g., US Patent Publication No. US2024/0085633A1; and publications referenced therein). Spring member CS biases against the top of the block P. The block P has a top portion provided with a recess H along the vertical (Z) axis for receiving oval coil spring CS. Recess H may be a concentric recess conforming to the sectional profile of coil spring CS, as illustrated.

Cover CV is securely but removably attached to bracket F (e.g., using screw fasteners SW), with the spring member CS in a compressed state between cover CV and connector unit C. Coil spring CS is compressed between cover BC and connector unit C to press on recess H. The underside of cover CV may have a matching concentric recess, and/or a protrusion, to receive and/or locate the top end of coil spring CS to prevent it from sliding horizontally along the underside of cover CV. Spring member CS between the portion of cover CV and connector unit C provides a preload to bias connector unit C in a vertical direction perpendicular towards the first and second coupling surfaces S1 and S2. However, cconnector unit C is not constrained by fixed attachment to cover CV or bracket F and is moveable in a direction perpendicular to receptacle R against the bias of spring member CS. Connector unit C is therefore not constrained to an extent for a desired tolerance range of lateral movements in a horizontal plane parallel to the plane of the receptacle R. Connector unit C is therefore permitted to move within a desired tolerance range relative to the cover and receptacle, with degrees of freedom including at least translations along vertical axis (Z-axis) and horizontal axes in a horizontal plane parallel to the coupling surface of the receptacle (X-axis and Y-axis orthogonal to the Y-axis) and rotation about vertical axis (Z-axis) (and further to some extent about the horizontal axes). The extent of such movement would depend on the extent of spring bias (and/or flexure) of the spring member CS.

As illustrated in the embodiments throughout, with the spring members CS in a compressed state between common cover CV and connector units C, each connector unit C is not constrained by fixed attachment to cover CV or bracket F and is therefore moveable relative to each other. When cover CV is attached to bracket F, spring members CS provide independent preloads biasing the connector units C independent of one another. In this locked position, connector units C are securely positioned with respect to bracket F (and hence to substrate 2 and optoelectronic unit OE thereon), and the spring members CS within connector units C continue to maintain a bias on first coupling surfaces S1 against second coupling surfaces S2 of receptacles R, to maintain passive demountable coupling between connector units C and receptacles R.

In particular, complementary first and second passive alignment features A1 and A2 on the first and second coupling surfaces S1 and S2 correspond to at least one of kinematic coupling, quasi-kinematic coupling, and elastic averaging coupling. In the illustrated embodiment, the first and second passive alignment features A1 and A2 conform to elastic averaging coupling, comprising a first two-dimensional array of alignment features A1 on the first coupling surface S1 of the connector unit C, and a second two-dimensional array of alignment features A2 on the second coupling surface S2 of the receptacle, wherein the first coupling surface S1 is removably attachable to the second coupling surface S2 to define a demountable coupling, with the first array of alignment features A1 against the second array of alignment features A2 to define an elastic averaging coupling, thereby passively aligning and demountably coupling the first coupling surface S1 to the second coupling surface S2. Repeatable spatial alignment should be maintained for subsequent repeated demounting and coupling of the connector unit to receptacle. The characteristics and benefits of deploying a demountable elastic averaging coupling for optical connectors and receptacles have been extensively discussed in assignee's earlier patent publications (e.g., US Patent Publication Nos. 2024/0085633A1; 2024/0142722A1; 2016/0161686A1 and U.S. Pat. No. 11,500,166B2; and publications referenced therein) which disclose elastic averaging features suitable for connection of an optical connector to receptacle and other support foundations. References can be made to these earlier publications for further details and adoption for the present invention, which concepts when considered alone are not germane to the practice of the present invention.

In accordance with the present invention, a desired tolerance range is provided to allow the connector units C to be movable relative to the bracket F (and hence relative to receptacles R and optoelectronic unit OE), with degrees of freedom including translations along vertical axis (Z-axis) and horizontal axes in a horizontal plane parallel to the second coupling surface of the receptacle (Y-axis along the optical axis of the optical fibers O and X-axis orthogonal to the Y-axis) and rotation about vertical axis (Z-axis) (and further to some extent about the horizontal axes).

To mount connector units C to the receptacles R, connector units C are each bonded to base of block P (e.g., via glue, solder, or laser welding). As shown in FIG. 2B, connector units C are placed on corresponding receptacles R, with facing coupling surfaces S1 and S2 generally and gently touching. Fiber arrays FO and FA received and guided by channels provided on a gasket GF provided at an edge of the bracket F. Spring member CS is placed in the recess H at top of block P. Cover CV is pressed onto spring members CS and is removably attached to bracket F (e.g., using screw fasteners) to keep spring members CS in a biased state (i.e., under compression), and to keep the fiber arrays in the channels of the gasket GF. Spring members CS bias connector units C against the receptacle R to seat and mate the complementary passive alignment features A1 and A2 on the facing coupling surfaces S1 and S2, thereby facilitating demountable mechanical coupling of connector unit C to receptacles R/optoelectronic unit OE. Connector units C are each separately movable relative to each other to separately locate on and align with a corresponding receptacle, thereby allowing passive alignment features A1 of each connector unit C to locate, seat and mate with passive alignment features A2 of corresponding receptacle R, thereby physically and optically aligning connector units C to receptacles R/optoelectronic unit OE. Given the individual connector units C can move relative to each other below the cover CV to seek passive alignment with corresponding receptacles, as a result, misalignment considerations between the connector units and the associated optoelectronic unit is confined to possible “local” misalignment to an extent associated to and limited to the relatively small footprint of relatively smaller form factor of individual connector unit and corresponding receptacle, as compared to potential cumulative misalignment of connector unit(s) if they were fixedly attached within the overall relatively large/wide footprint of a relatively large form factor for a high density optical connector module.

Connector units C are independently movable to separately locate and demountably coupled to a corresponding receptacle R under the preload of spring member CS to mate or seat the first and second passive alignment features A1 and A2 on facing first and second coupling surfaces S1 and S2, thereby achieving final fine alignment by passively aligning each connector unit with a corresponding receptacle. By predefining the amount of preload to be exerted by spring members CS on connector units C, when mounting/assembling connector units C onto receptacles R, spring members assert a predefined amount of preload on connector units without overloading for purpose of seating and mating passive alignment features A1 and A2 on facing coupling surfaces S1 and S2.

The complementary passive alignment features A1 and A2 provides repeatable, fine alignment between corresponding pair of connector unit C and receptacle R. In addition, coarse alignment guide features may be provided. More than one set of coarse alignment guide features may be provided to provide a sequence of coarse alignments leading to final fine alignment of the passive alignment features A1 and A2. For example, screws SW may function as the first level coarse alignment guides to position spring members CS initially to roughly position connector units C relative to receptacles R (first level coarse alignment). Second level coarse alignment guide features structured to facilitate guiding the respective connector units C to mate with the corresponding receptacle R at the interfacing first and second passive alignment features A1 and A2. For example, matching pins and holes (not shown) may be provided on coupling surfaces S1 and S2 with sufficient tolerance to facilitate further coarse positioning of connector units C with respect to receptacles R (a second level coarse alignment).

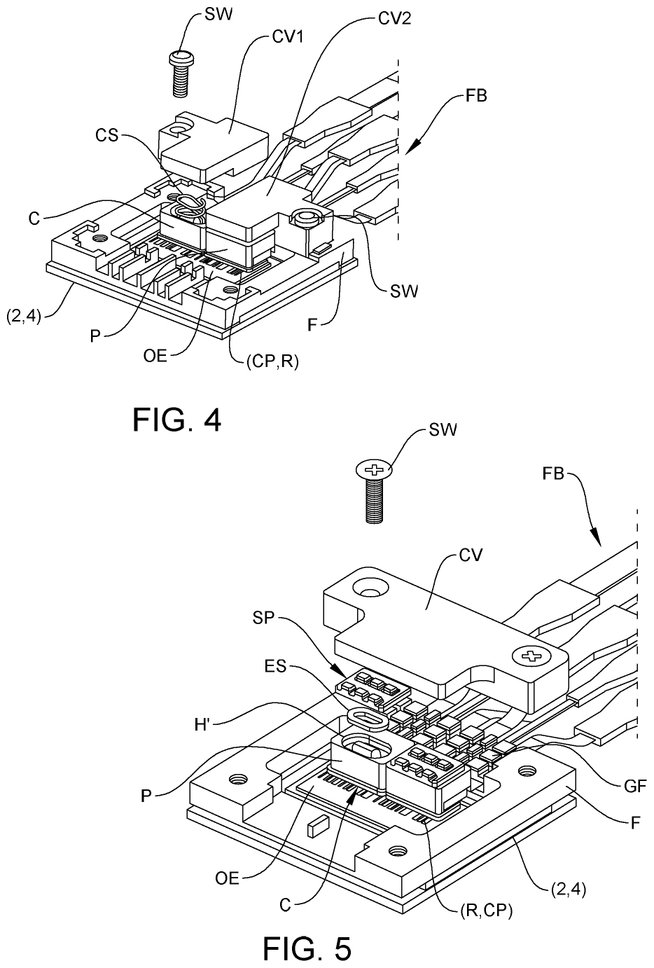

FIG. 4 illustrates mounting connector units C with an inventive fixture deploying a cover having multiple cover sections, e.g., a split cover (i.e., a two-section cover) comprising separate cover sections CV1 and CV2, in accordance with another embodiment of the present invention. Separate cover sections CV1 and CV2 are separately attached to the bracket F, using screw fasteners SW. Each cover section CV1/CV2 corresponds (i.e., cover) to at least one connector unit C (e.g., in embodiments having more than two connector units preloaded by spring bias under the cover). Other than the split cover, the structures and features of various components and subassembly thereof (e.g., connector units C, receptacles R, spring members CS, etc.) in this embodiment can be generally similar to the previous embodiment in FIG. 2.

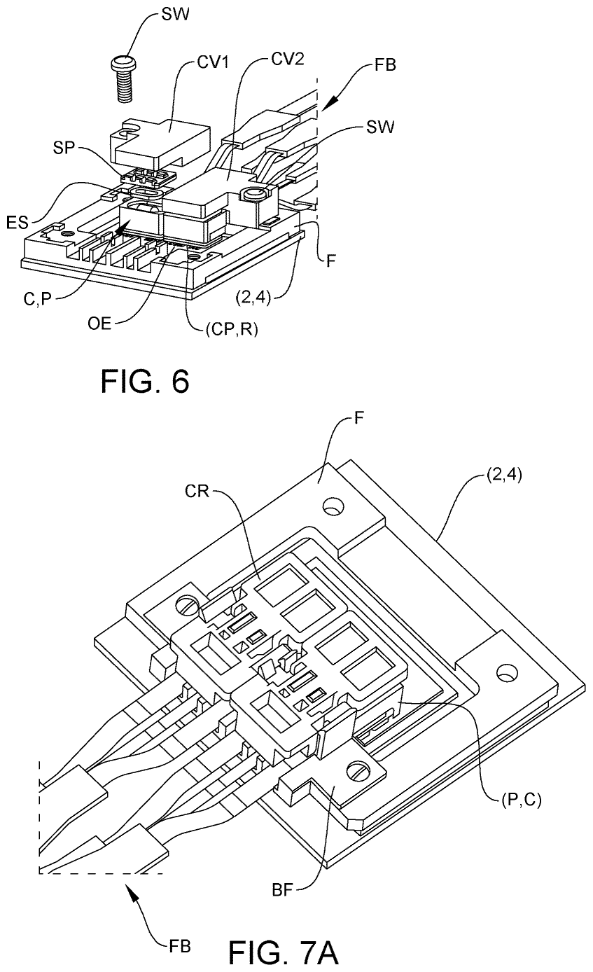

FIG. 5 illustrates mounting connector units C with an inventive fixture deploying elastomeric springs ES, in accordance with yet another embodiment of the present invention. This embodiment is quite similar to the previous embodiments, with major differences directed to modifications adopting a biasing element in the form of elastomeric springs. Otherwise, the structure of connector assembly units C and receptacles R are generally similar to that in the earlier embodiments.

As illustrated in this embodiment, elastomeric spring ES is generally ring shaped (e.g., toroidal shaped, or doughnut shaped), received in matching concentric recess H′ (which may be shallower than the recess H in the previous embodiment. Spring ES in its uncompressed state should be of sufficient size to provide a desired preload force on block P when in its compressed state after cover CV is removably attached to bracket F. In addition, a spacer SP may be provided between spring ES and cover CV to maintain spring ES in the recess, and to take up clearance space between spring ES and underside of cover CV. Spacer SP is resilient, e.g., made of rubber or other elastomeric material. The combination of spring ES and spacer SP provides the desired preload when cover CV compresses thereon when attached to bracket F. Other than the elastomeric spring ES and spacer SP, the structures and features of various components and subassembly thereof (e.g., connector units C, receptacles R, etc.) in this embodiment can be generally similar to the previous embodiment in FIG. 2.

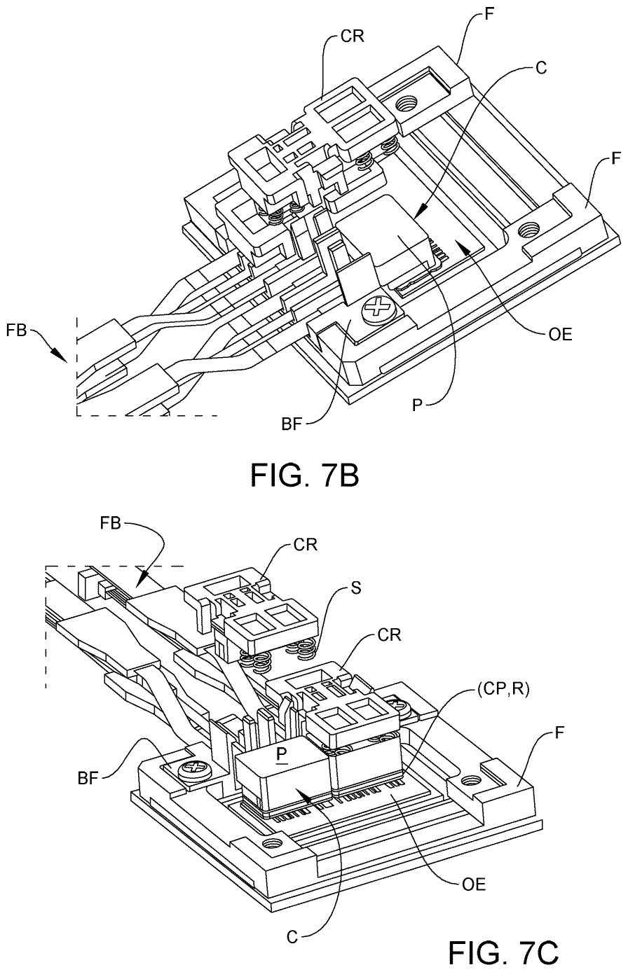

FIG. 6 illustrates mounting connector units with an inventive fixture deploying elastomeric springs and a split cover, in accordance with yet another embodiment of the present invention. Separate covers CV1 and CV2 are separately attached to the bracket F, using screw fasteners SW. Other than the split cover, the structures and features of various components and subassembly thereof (e.g., connector units C, receptacles R, spring members CS, etc.) in this embodiment can be generally similar to the previous embodiment in FIG. 5.

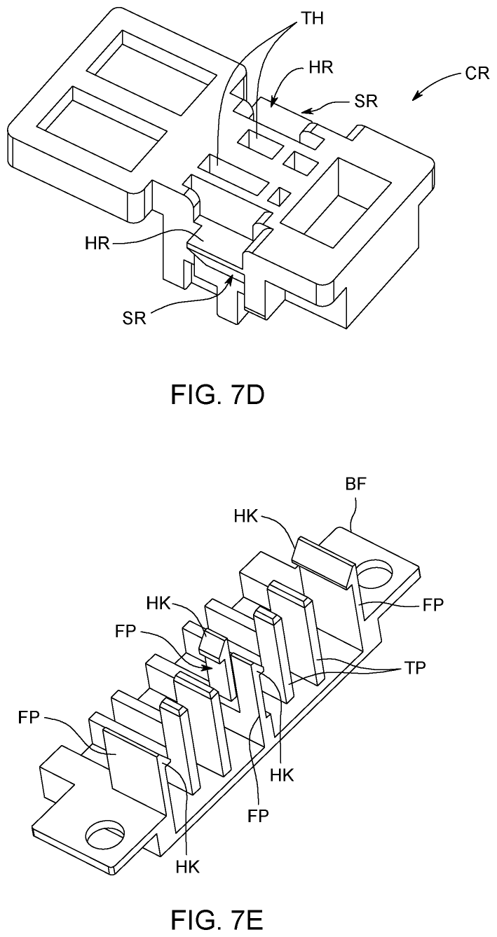

FIGS. 7A to 7E illustrate mounting connector units with an inventive fixture, in accordance with a further embodiment of the present invention. This embodiment shares general similar features (e.g., connector units C, receptacles R) of previous embodiments, with exception of the mounting fixture features in this embodiment. In this embodiment, the mounting fixture includes a combination of vertically extending flat prongs FP and covers CR. The prongs P are flexible, each having a distal end configured with a hook HK to engage complementary recesses HR on corresponding covers CR. Springs S are provided under cover CR to bias a preload on block P of each connector units C.

When mounting connector unit C onto receptacle R, cover CR is pressed onto block P of connector unit C against bias of spring S. Cover CR has ramp surfaces SR defined on the sides, which initially move the facing hooks HK to spread flexible prongs FP apart, which subsequently latch onto corresponding recesses HR. A pair of facing prongs FP engage recesses HR on both sides of cover CR. Pairs of prongs FP and matching recesses HR may be offset between the sides to provide indexing to attached cover CR to prongs FP in a unique defined configuration. Prongs FP may extend from bracket F, or from a base BF attached to bracket F. In addition, posts TP extends from the base BF, which are inserted into the through holes TH to guide cover CR to spread prongs FP to initially move the facing hooks HK apart to subsequently latch onto corresponding recesses HR. Pairs of posts TP and matching through holes TH may be offset in size to provide indexing to attached cover CR to prongs FP in a unique defined configuration. To remove connector units C from the base BF, prongs FP are spread apart to release the hooks HK from corresponding recesses HR.

Prongs FP and/or posts TP and complementary recesses HR and/or through holes TH may provide level one coarse alignment guide features. Similar level two coarse alignment guide features may be provided for guiding final fine alignment of the connector units C and receptacles R.

While the inventive concepts have been described in connection with a pair of connector units and a matching pair of receptacles, the concepts herein may be applied to scale to a mounting fixture for demountably coupling a larger number of connector unit/receptacles pairs by passive alignment, using a single cover or multiple covers to maintain preload bias on the connector units against the corresponding receptacles.

Based on the above disclosed embodiments, it can be realized that the present invention achieves at least the following advantages:
(a) In all embodiments, the connector units are allowed to move to seek fine alignment, which is particularly useful for kinematic, quasi-kinematic, and elastic averaging couplings, without over constraining movements of the connector units.
(b) By predefining the amount of preload to be exerted by the biasing member (e.g., spring member) on each connector unit, when mounting/assembling the connector units onto receptacle, the spring member asserts a predefined amount of preload on each connector unit without overloading for purpose of seating and mating the passive alignment features on facing coupling surfaces.
(c) Constant preload biasing of connector units within the mounting fixture can accommodate thermal induced dimensional variations.
(d) Connector assemblies of large form factors may be achieved with large number of connector units, with individual connector units independently movable, which can independently align and maintain alignment. Misalignment considerations between the array of connector units in the optical connector assembly and the array of optoelectronic units is confined to possible “local” misalignment to an extent associated to and limited to the relatively small footprint of relatively smaller form factor of a complementary pair of receptacle and connector unit, as opposed to potential cumulative misalignment of a linear array of connector units if they were fixedly attached to the overall relatively large/wide footprint of relatively large form factor connector assembly.
(e) Individual connector units may be removed along with associate fiber array from the connector assembly and easily replaced, if necessary, without wasting the remaining components. The connector units are not bonded to any bracket or cover.
(f) The fiber array subassemblies including optical benches are pretested and supplied as “known good cables” that reduce handling at the assembly location for connector assemblies, or at field locations. The fiber array subassemblies undergo a series of screening tests to determine “known good cables” before forwarding for use in connector assemblies.
(g) During the service life of the connector assemblies, a faulty fiber array subassembly is replaceable with a good subassembly to extend the overall service life of the significantly more expensive connector assemblies.
(h) Sequential coarse alignment features provide at least one or more levels of coarse alignment of the connector assembly prior to the final fine alignment of the connector unit to the receptacle.
(i) If the connector assembly is deployed for use with CPO, the foregoing flexibility of the inventive connector assembly reduces potential costs of having to replace an entire CPO when prior art connector assemblies are otherwise permanently attached to the CPO substrate.

While the invention has been particularly shown and described with reference to the preferred embodiments, it will be understood by those skilled in the art that various changes in form and detail may be made without departing from the spirit, scope, and teaching of the invention. Accordingly, the disclosed invention is to be considered merely as illustrative and limited in scope only as specified in the appended claims.

1. A mounting fixture for mounting a plurality of connector units to a receptacle associated with an optoelectronic unit, comprising:
an array of at least two discrete connector units corresponding to the receptacle, wherein each connector unit comprises at least one optical bench having a body supporting an array of optical fibers for inputting/outputting optical signals to/from corresponding array of I/O ports of the optoelectronic unit, wherein each connector unit comprises a first coupling surface provided with first passive alignment features matching complementary second passive alignment features provided on a second coupling surface of the receptacle, and wherein removably mating the first passive alignment features and the second passive alignment features forms a demountable coupling between the first coupling surface and the second coupling surface;
a bracket securely positioned in relation to the receptacle;
a cover attached to the bracket; and
a biasing member between the cover and the connector units, providing a preload biasing each connector unit in a vertical direction perpendicular towards the first coupling surface, wherein the biasing member biases the connector units against the receptacle to seat and mate the complementary first and second passive alignment features on the facing first and second coupling surfaces, thereby facilitating demountable mechanical coupling of the connector units to the receptacle.
